(19) United States
(12) Patent Application Publication
(10) Pub. No.: US 2026/0322996 A1
(43) Pub. Date: Oct. 15, 2026

(54) BOUNDARY SAMPLE DERIVATION IN VIDEO CODING

(71) Applicant: MEDIATEK INC., Hsinchu City (TW)

(72) Inventors: Yu-Cheng LIN, Hsinchu City (TW); Tzu-Der CHUANG, Hsinchu City (TW); Chih-Wei HSU, Hsinchu City (TW); Ching-Yeh CHEN, Hsinchu City (TW); Yi-Wen CHEN, San Jose, CA (US)

(21) Appl. No.: 19/104,289

(22) PCT Filed: Aug. 18, 2023
(86) PCT No.: PCT/CN2023/113877

§ 371 Date: Feb. 17, 2025

Related U.S. Application Data
(60) Provisional application No. 63/371,883, filed on Aug. 19, 2022.

(51) Int. Cl. H04N 19/105; H04N 19/159; H04N 19/172; H04N 19/176

(52) U.S. Cl. CPC H04N 19/105; H04N 19/159; H04N 19/172; H04N 19/176

(57) ABSTRACT

A video coding method that generates and uses out-of-bound (OOB) padding samples as reference is provided. A video coder receives data to be encoded or decoded as a current picture of a video. The video coder generates OOB padding samples of the current picture by using a motion information of a boundary block of the current picture to fetch samples of a first reference block in a first reference picture. The video coder computes an offset value based on a first DC value of the boundary block and a second DC value of the first reference block. The first and second DC values are calculated based on reconstructed samples without in-loop filtering. The video coder applies the offset value to the padding samples. The video coder derives a candidate reference picture based on the current picture and the padding samples for encoding or decoding a subsequent picture in the video.

### CROSS REFERENCE TO RELATED PATENT APPLICATION(S)

The present disclosure is part of a non-provisional application that claims the priority benefit of U.S. Provisional Patent Application No. 63/371,883, filed on 19 Aug. 2022. Content of the above-listed application is herein incorporated by reference.

### TECHNICAL FIELD

The present disclosure relates generally to video coding. In particular, the present disclosure relates to methods of handling out-of-boundary samples.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs).

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a video coding method that generates and uses out-of-bound (OOB) padding samples as reference. A video coder receives data to be encoded or decoded as a current picture of a video. The video coder generates OOB padding samples of the current picture by using a motion information of a boundary block of the current picture to fetch samples of a first reference block in a first reference picture. The video coder computes an offset value based on a first DC value of the boundary block and a second DC value of the first reference block. The first and second DC values are calculated based on reconstructed samples without in-loop filtering. The video coder applies the offset value to the padding samples. The video coder derives a candidate reference picture based on the current picture and the padding samples for encoding or decoding a subsequent picture in the video. For example, a block in the subsequent picture of the video maybe encoded by motion compensation using the OOB padding samples because the block references OOB samples of the current picture.

In some embodiments, OOB padding samples in a corner region outside the current picture are generated based on a boundary block at the corner of the current picture. The first reference block may provide samples that span both sides of the boundary of the current picture. When using the motion information of the boundary block to generate the OOB samples, the video coder may update the motion information based on a position of the OOB samples relative to the boundary of the current picture.

In some embodiments, the boundary block may be coded by bi-prediction based on first and second motion vectors, the first motion vector referencing the first reference block and the second motion vector referencing a second reference block in a second reference picture. The video coder may select one of the first and second reference blocks based on whether the first or second reference blocks are OOB. In some embodiments, when the first and second reference blocks are not OOB, the video coder may select one of the first and second reference blocks based on which of the first and second reference blocks has a smaller quantization parameter (QP), or based on which of the first and second reference pictures has a smaller temporal distance.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 illustrates using motion compensated prediction to extend a reference picture for out-of-bound (OOB) referencing.

FIG. 2 conceptually illustrates boundary pixel padding of a reference picture using motion compensation.

FIG. 3 conceptually illustrates motion compensated boundary padding for a reference picture.

FIG. 4 illustrates using motion compensation (MC) to deriving a M×4 padding block.

FIG. 5 conceptually illustrates using a bi-predicted adjacent boundary block to perform MC padding.

FIG. 6 illustrates applying an offset value to correct pixels in a MC padding block.

FIG. 7 shows a bi-directional inter-prediction based on an OOB reference block.

FIG. 8 illustrates motion compensation for generating OOB padding samples at corner boundary of a reference picture.

FIGS. 9A-B conceptually illustrate selecting one of two motion vectors for a bi-prediction block based on OOB checks and QP values.

FIG. 10 illustrates coding a bi-prediction current block when one of the two reference blocks is OOB.

FIG. 11 illustrates a bi-prediction current block when both reference blocks are OOB.

FIG. 12 illustrates an example video encoder that may use motion compensation to generate OOB padding samples.

FIG. 13 illustrates portions of the video encoder that derive OOB padding samples.

FIG. 14 conceptually illustrates a process for generating and using padding samples in OOB regions of a reference picture.

FIG. 15 illustrates an example video decoder that may use motion compensation to generate OOB padding samples.

FIG. 16 illustrates portions of the video decoder that derive OOB padding samples.

FIG. 17 conceptually illustrates a process for generating and using padding samples in OOB regions of a reference picture.

FIG. 18 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Reference Picture Boundary Padding

In some embodiments, reference pictures may be extended by a perpendicular padding of the picture boundary samples. Boundary padding may also use either inter-prediction-based techniques or intra-prediction-based techniques.

When motion compensation is performed in the decoder side, it is possible that the motion vector point to a reference block that is partially or entirely located outside the reference slice. Without boundary padding, these pixels will be unavailable. The reference slice may be padded using repetitive padding method which repeats the outer most pixel in each of the four directions for a certain number of times depending on the padding size. These padded pixels can only provide very limited information since it is very likely that the padded area does not contain any meaningful content compared to those that lie within the boundary.

In some embodiments, a boundary pixel padding method that allow more information to be provided by the padded area in the reference slice is used. In the method, a motion vector is first derived from a boundary 4×4 block inside the current frame. If the boundary 4×4 block is intra-coded or if the motion information is not available, repetitive padding will be used. If the boundary 4×4 block is predicted using uni-directional inter prediction, the only motion vector within the block will be used for motion compensated boundary pixel padding.

Inter-prediction-based boundary padding uses motion compensated prediction to extend the area of a (primary, or first order) reference picture. The boundary extension area of the (first order) reference picture may be divided into blocks of 4×M or M×4 samples. Each block (in the boundary extension area) is filled with samples generated by motion compensation (MC) using the motion information of the adjacent reference picture block, the motion information may refer to the reference picture's reference picture (or secondary reference picture, or second order reference picture.)

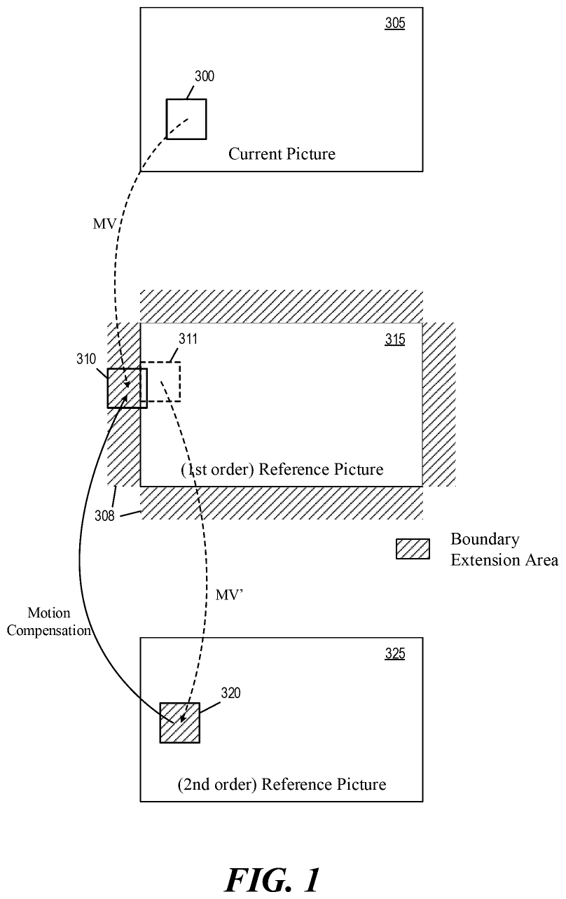

FIG. 1 illustrates using motion compensated prediction to extend a first order reference picture for OOB referencing. In the figure, a current block 300 in a current picture 305 has a MV that refer to a reference block 310 in a first order reference picture 315. The reference block 310 is at least partially OOB and lies in the boundary extension area (or padding area or OOB region) 308 of the reference picture 315. In some embodiments, the video coder may use the available motion information of an adjacent or nearby reference block 311 to perform motion compensation to construct the padding samples of the OOB reference block 310. The video coder may use the motion information (or a derived motion information thereof) to identify padding samples for the reference block 310. In this case, the motion information of the adjacent reference block 311 refers to samples in a second order reference block 320 in a second order reference picture 325. The referred samples of the second order reference block 320 is in turn used to perform MC to provide the padding samples of the OOB reference block 310. In some embodiments, the padding samples may be identified and derived when the first order reference picture 315 is decoded (for example, the first order reference picture 315 is decoded as a current picture before taken as a reference picture), and the second order reference picture 325 is the reference picture for decoding the first order reference picture 315.

For boundary extensions blocks without associated motion information and for boundary extension areas for which motion information points outside of the second order reference picture, fallback perpendicular padding may be carried out. In some embodiments, the padding entails addition of an average residual offset to the boundary extension samples. In some embodiments, the padding is based on bi-prediction of boundary extension samples.

Intra-prediction-based boundary padding uses angular intra-prediction to fill the (boundary extension) area of a referenced block outside the reference picture. In some embodiments, the applied angular intra-prediction mode is chosen in encoder and decoder using a probing approach of decoded picture samples.

In some embodiments, an inter/intra-prediction-based boundary padding method is used to combines per-picture inter-prediction-based boundary padding with per-reference intra-prediction-based boundary padding. After generation of the inter-prediction-based boundary padding, for each reference block entailing boundary padding samples, the number of boundary padding samples originating from perpendicular boundary padding is evaluated. If this number exceeds a threshold (50% of boundary padding samples), intra-prediction-based boundary padding is used for the reference block instead of inter-prediction-based boundary padding.

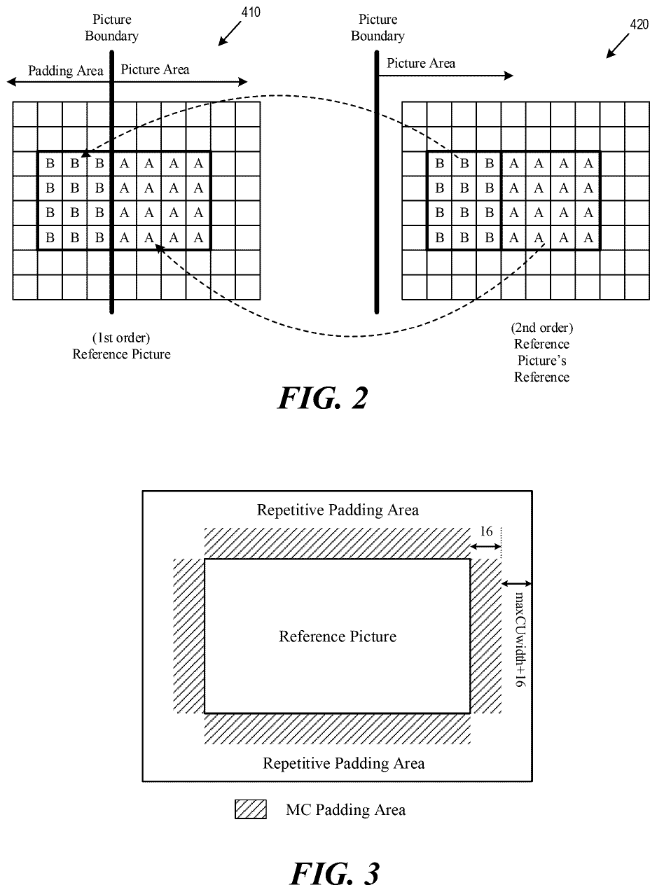

In some embodiments, OOB areas (boundary extension area) outside of a reference picture are padded by extrapolating edge pixel of the picture. In some embodiments, a boundary pixel padding method is used for padding outside areas of a picture by motion compensation using motion information of edge pixels of the picture. FIG. 2 conceptually illustrates boundary pixel padding of a reference picture using motion compensation. The figure illustrates a portion of a (first order) reference picture 410 and a portion of a second order reference picture 420 that is serving as a reference of the reference picture 410. The reference picture 410 has in-bound samples (labeled ‘A’) that are within the boundary of the reference picture 410. The in-boundary samples may be reconstructed by motion compensation based on the second order reference picture 420. Beyond the boundary of the reference picture 410 is the OOB padding area. The OOB samples in the padding area are provided by motion compensation based on in-boundary samples (labeled ‘B’) of the second order reference picture 420.

To use the motion information of the edge pixels, each 4×4 block is checked at the boundary of the (first order) reference picture. If there is motion information in the 4×4 block, the location of the 4×4 block is checked in the reference picture of the block. If the location is located in the image area of the reference picture, the video coder checks whether the adjacent/neighboring area of the reference area (the 4×4 block) is available (i.e., has motion information and/or within boundary of the reference picture.)

The location of the neighboring area may be located in four directions, up, down, left, right (of the reference 4×4 block). The orientation/direction of the adjacent/neighboring area is the same as the location of the padding area. For example, if the padding area is located on the left side of the picture, then the inspection area is also on the left side of the pixel. In addition, the length of the side that does not face the picture of the padding area is determined by (i) the distance between the position of the pixel of the reference picture and the position of the edge pixel or (ii) the size of the padding area. The shorter of the two lengths determined by (i) and (ii) is used to determine the length of the side that does not face the picture of the padding area. If the predetermined length is shorter than the size of the padding area, the rest of the area is filled with extrapolated edge pixels of the external picture.

The available adjacent area is derived by motion compensation. However, a conventional padding method is performed when an adjacent area is unavailable or there is no information about a motion in a boundary block. The block can have two pieces of information about movement. In this case, each piece of information is used to create a padding image and to integrate two images into one. In addition, the last pixel of each position is extrapolated to induce a left upper portion, a right upper portion, a left lower portion, and a right padding area.

In some embodiments, a corresponding starting position can be computed in the reference frame using the position of the boundary 4×4 block and its motion vector. From this starting position till the boundary of the reference slice in the given padding direction, a 4×M or M×4 image slip may be fetched where M is the distance between the horizontal/vertical coordinate of the boundary pixel position and the starting position depending on the padding direction. In this example, M is forced to be smaller that 64. In case of bi-directional inter prediction, only the motion vector, which points to the pixel position farther away from the frame boundary in the reference slice in terms of the padding direction, is used in motion compensated boundary pixel padding. In some embodiments, the difference between the DC value of the boundary 4×4 block in the current slice (e.g., the mean of all pixel values in the 4×4 block) and the DC value of the corresponding reference 4×4 block in the reference slice is used as the offset to filter the fetched motion compensated image slip before it is copied to the padding area beyond the image boundary.

In some embodiments, bi-directional inter-prediction is performed in a way to avoid relying on reference samples out of a reference picture bounds (OOB). Specifically, in the case of a bi-predicted block with an OOB reference block in one of the two reference pictures, the OOB prediction samples are not used. The relevant portion of the block being coded is instead uni-predicted based on non-OOB prediction samples, if available in the other reference picture. However, for a uni-predicted block with an OOB reference block or for a bi-directional predicted block with both OOB reference samples, repetitive padded pixels are used for motion compensation. Specifically, in some embodiments, pictures are extended by an area surrounding the picture with a size of (maxCUwidth+16) in each direction of the picture boundary. The pixel in the extended area is derived by repetitive boundary padding. When a reference block used for uni-prediction is located partially or completely out of the picture boundary (OOB), the repetitive padded pixel is used for motion compensation (MC).

In some embodiments, a motion compensated boundary padding method replaces the repetitive boundary padding, for increased coding efficiency. FIG. 3 conceptually illustrates motion compensated boundary padding for a reference picture. In the figure, some of the samples outside of the picture boundary are derived by motion compensation, instead of using only repetitive padding. The total padded area size may be increased by 64 or 16. This is to keep MV clipping, which implements repetitive padding, non-normative.

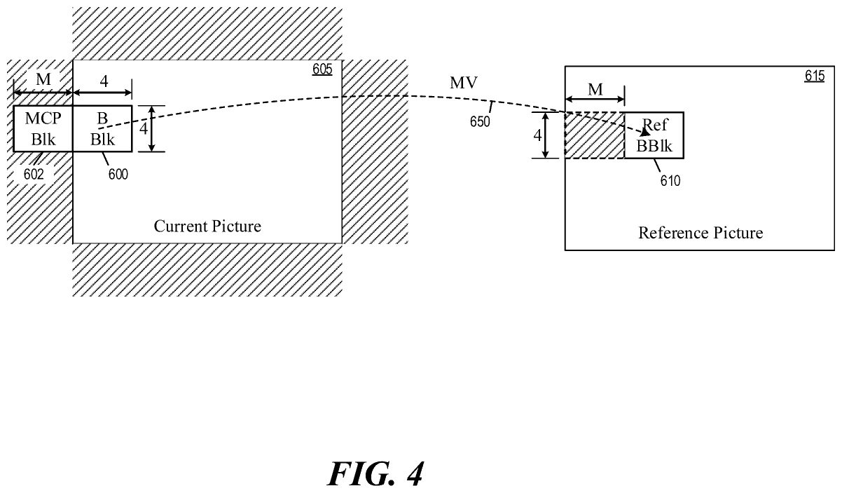

In some embodiments, for motion compensation padding, MV of a 4×4 boundary block is utilized to derive a M×4 or 4×M padding block. FIG. 4 illustrates deriving a M×4 padding block. As illustrated, a M×4 padding block 602 is in a left padding direction in a current picture 605, which will be referenced by a subsequent picture (not illustrated.) A boundary block 600 adjacent to the M×4 padding block 602 has motion information (MV 650) that point to a reference block 610 in a reference picture 615. The value M is derived as the distance of the reference block 610 to the picture boundary. In some embodiments, M is set to 4 or greater as long as the motion vector 650 (of the boundary block 600) points to a position within boundary of the reference picture 615. If the boundary block 600 is intra coded, then MV 650 is not available, and M is set equal to 0. If M is less than 64, the rest of the padded area is filled with the repetitive padded samples.

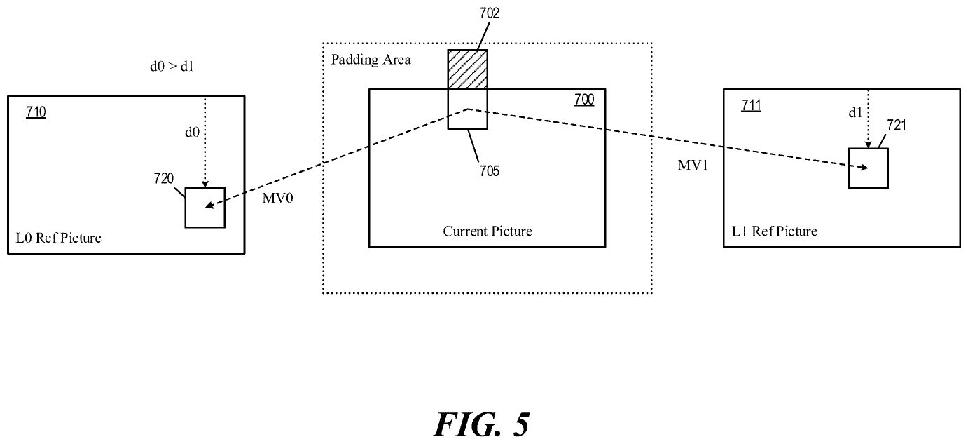

In some embodiments, if the motion information of the adjacent boundary block (e.g., 600) is for bi-directional inter prediction, only one prediction direction is selected and used in MC boundary padding. The selected prediction direction is the one with a motion vector pointing to a pixel position in the second order reference picture that is farther away from the picture boundary (e.g., larger M value) than the motion vector of the non-selected prediction direction. FIG. 5 conceptually illustrates using a bi-predicted adjacent boundary block to perform MC padding. In the figure, a MC padding block 702 is OOB above a current picture 700. The motion information of a boundary block 705 that is adjacent to the MC padding block 702 is used to generate the padding samples for the padding block. The adjacent boundary block 705 is a bi-prediction block having a L0 MV pointing to a reference block 720 in a L0 reference picture 710 and a L1 MV point to a reference block 721 in a L1 reference picture 711. In the example, since the MC padding block is in a direction above the boundary and above the boundary block 705, the MC padding process would select the L0 MV to perform MC for padding. This is because the L0 reference block 720 is further away from the above picture boundary than the L1 reference block 721.

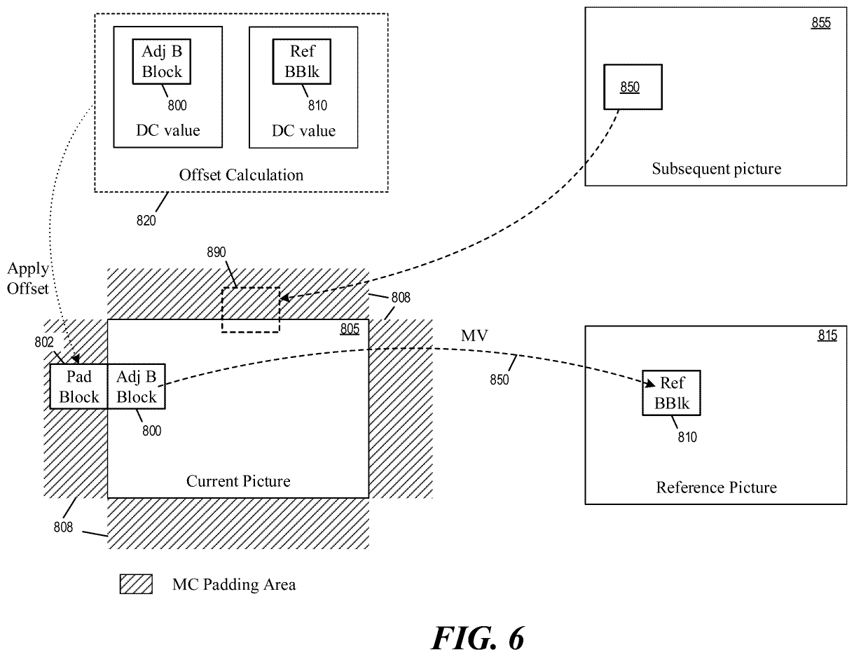

As mentioned, in some embodiments, the pixels in MC padding block are corrected with an offset, which is equal to the difference between the DC values of the reconstructed boundary block and its corresponding reference block. FIG. 6 illustrates applying an offset value to correct pixels in a MC padding block. The figure illustrates a MC padding block 802 that is in a OOB padding region 808 of a current picture 805. The OOB padding region 808 is to be filled by samples from reference blocks that are identified by motion information of boundary blocks of the current picture 805. For example, a MC padding block 802 in the OOB padding region 808 is to be filled with samples by MC based on pixels from a reference block 810 in a reference picture 815. The reference block 810 is identified using motion information 850 of a boundary block 800 that is adjacent to the MC padding block 802 in the current picture 805.

When determining the padding samples of the MC padding block 802, an offset value 820 is applied to correct the padding samples in the MC padding area (or at least the padding block 802.) This offset value 820 is determined based on a difference between the DC value of the adjacent boundary block 800 and the DC value of the reference block 810, e.g., by having the DC value of adjacent boundary block 800 subtract the DC value of the reference block 810 and averaged (e.g., divide the result by 16.)

The current picture 805 with the OOB padding region 808 may then be used as a reference picture for subsequent pictures. (Thus, the current picture 805 serves as a first order reference picture and the reference picture 815 becomes a second order reference picture.) For example, if a future block 850 in a subsequent picture 855 uses the current picture 805 as a reference picture, specifically by referencing samples 890 that are at least partially OOB for motion compensation, the DC adjusted samples of the OOB padding region 808 may be used for reconstructing the future motion compensated block 850.

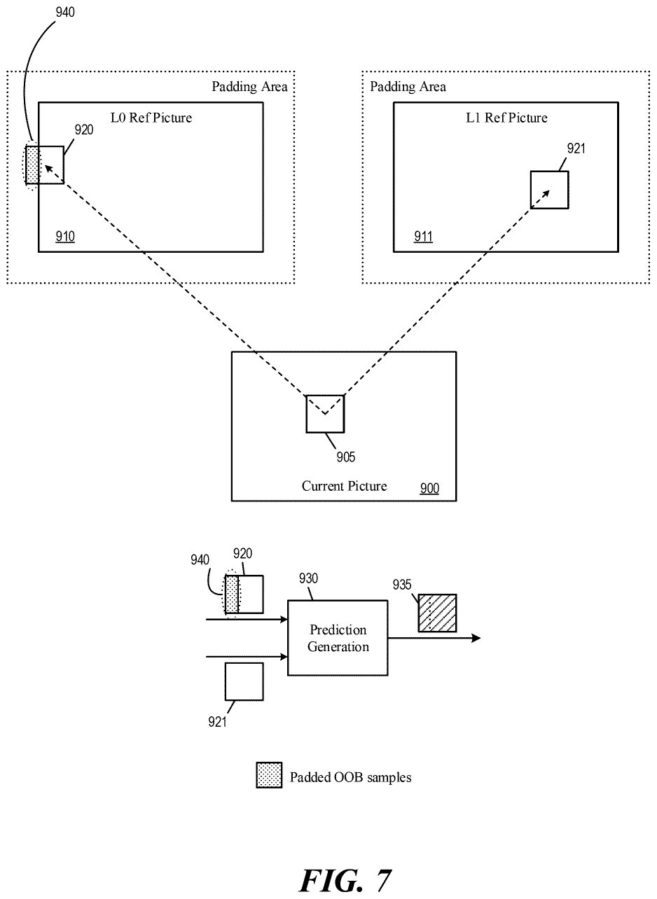

Due to the reference samples padding of the reference picture, it is possible for an inter-coded block (e.g., coding unit) to have a reference block located outside the reference picture partially or totally. FIG. 7 shows a bi-directional inter-prediction based on an OOB reference block. The figure shows bi-directional motion compensation being performed to generate an inter-prediction predictor of the current block. The inter-prediction is generated based on a list 0 reference block and a list 1 reference block. In the example, the list 0 reference block is partially out-of-boundary (OOB) while the list 1 reference block is fully inside the reference picture. The OOB part of the motion compensated blocks usually provides less prediction efficiency because the OOB part is populated with repetitive samples derived from the boundary samples within the reference picture.

In the figure, bi-directional motion compensation is performed to generate an inter prediction block (predictor) of a current block 905 in a current picture 900. A list 0 reference block 920 is partially out-of-boundary (OOB) of a reference picture 910. A list 1 reference block 921 is fully inside a reference picture 911. The OOB portion 940 of the reference block 920 is filled with repetitive padding samples when the video coder performing a prediction generation process 930. The prediction generation process 930 uses the reference blocks 920 and 921 to generate a prediction block 935 for the current block 905. Since the OOB portion 940 of the reference block 920 is padded with repetitive samples derived from the boundary samples within the reference picture 910, the part of a motion compensated block 935 that correspond to the OOB portion 940 may provide less prediction efficiency.

In some embodiments, when combining more than one prediction blocks, the OOB prediction samples are discarded, and the non-OOB prediction samples are used to generate the final predictor. Specifically, let Pos_x_{i,j} and Pos_y_{i,j} denote the x and y positions of one prediction sample (i, j) in one current block, and MV^{LX}_xᵢⱼ and MV^{LX}_yᵢⱼ (LX=L0 or L1) denote the MV of the current block; POS_{LeftBdry}, POS_{RightBdry}, POS_{TopBdry}, POS_{BottomBdry} are the positions of four boundaries of the picture. One prediction sample is regarded as OOB when at least one of the following conditions is satisfied:

$$( {Pos\_x}_{i , j} + {MV}^{LX} {\_x}_{i , j} ) > ( {Pos}_{RightBdry} + half\_pixel ) ,$$

$$( {Pos\_x}_{i , j} + {MV}^{LX} {\_x}_{i , j} ) < ( {Pos}_{LeftBdry} + half\_pixel ) ,$$

$$( {Pos\_y}_{i , j} + {MV}^{LX} {\_y}_{i , j} ) > ( {Pos}_{BottomBdry} + half\_pixel ) ,$$

$$( {Pos\_y}_{i , j} + {MV}^{LX} {\_y}_{i , j} ) > ( {Pos}_{TopBdry} + half\_pixel )$$

where half pixel is equal to 8 that represents the half-pel sample distance in the 1/16-pel sample precision. After examining the OOB condition for each sample, the final prediction samples of one bi-directional block is generated as follows:
If P^{L0}_{i,j} is OOB and P^{L1}ᵢⱼ is non-OOB, then P^{final}_{i,j}=P^{L1}_{i,j}
else if P^{L0}_{i,j} is non-OOB and P^{L1}_{i,j} is OOB, then P^{final}_{i,j}=P^{L0}_{i,j}
else P^{final}_{i,j}=(P^{L0}_{i,j}+P^{L1}_{i,j}+1)>>1

In some embodiments, the OOB checking is conducted prior to the bidirectional optical flow (BDOF) process, where the OOB samples in one uni-directional prediction block is replaced by its collocated prediction sample from the other direction if the collocated sample is non-OOB. Thus,
If P^{L0}_{i,j} is OOB and P^{L1}_{i,j} is non-OOB, then P^{L0}_{i,j}=P^{L1}_{i,j}
else if P^{L0}_{i,j} is non-OOB and P^{L1}_{i,j} is OOB, then P^{L1}_{i,j}=P^{L0}_{i,j}

Then, BDOF process or weighted averaging is applied to obtain the final predictor of the current block.

In some embodiments, after performing intra prediction-based or inter prediction-based approach to obtain reference samples (in the padding area of the first order reference picture), an offset term may be added to the reference samples. The offset may be pre-calculated or pre-stored during encoding or decoding. For picture corners, instead of repetitive padding, intra prediction-based approach or inter prediction-based approach is used to derive corner boundary samples. When OOB handling is enabled, inter prediction-based approach may further consider OOB reference blocks when motion compensation is performed for the current block.

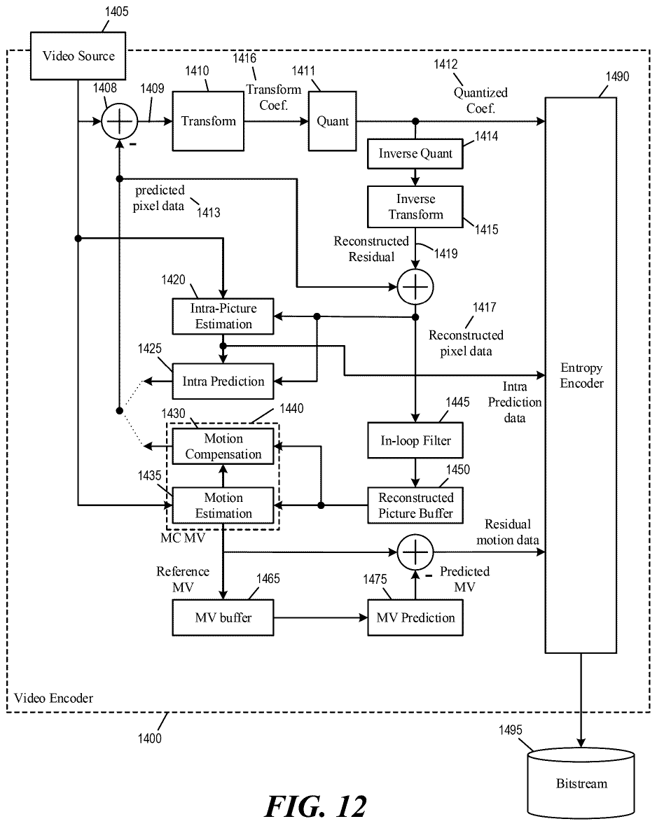

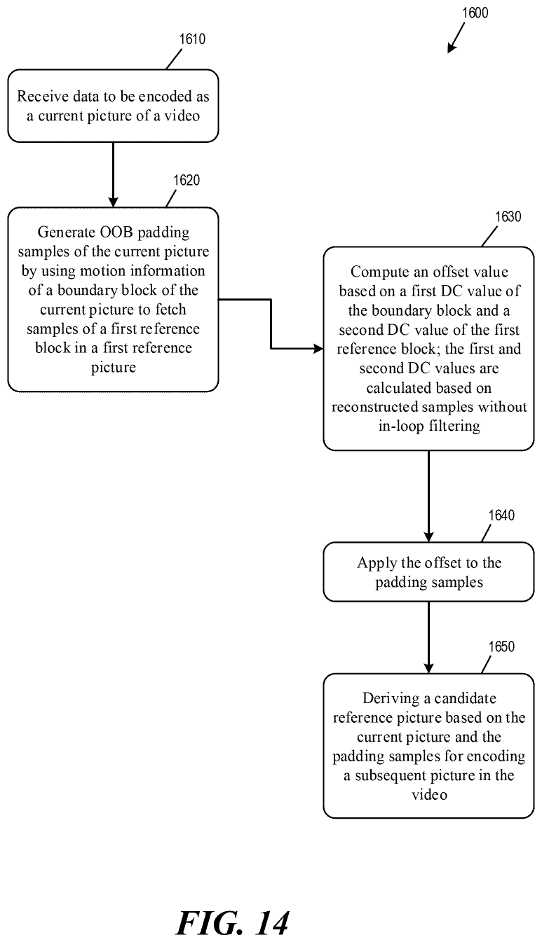

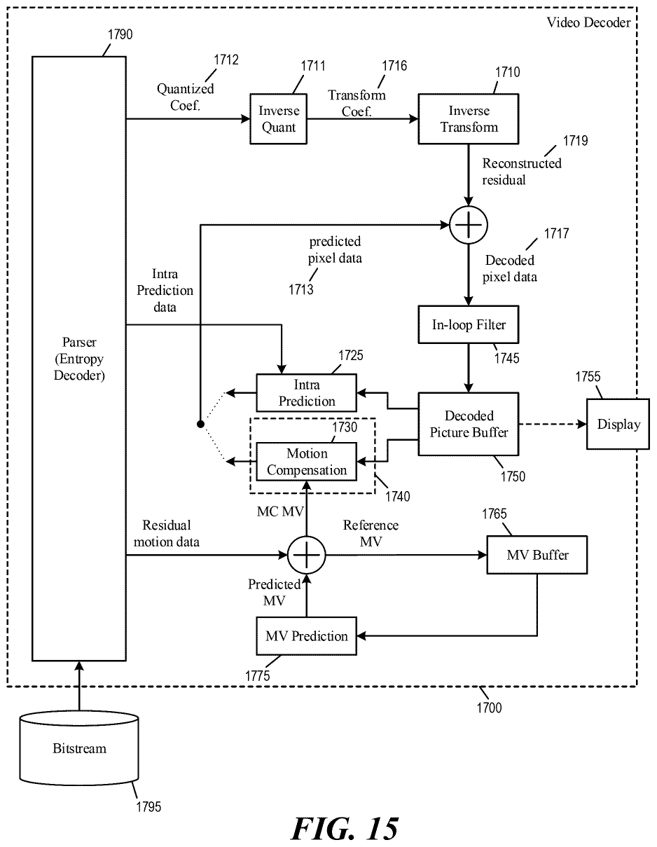

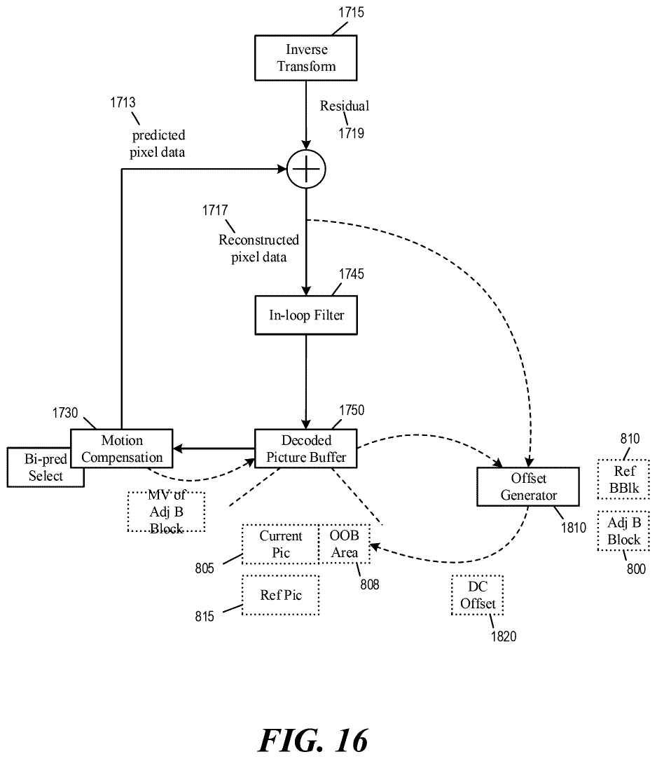

In some embodiments, reconstruction samples (of the first and second order reference pictures) before loop filtering (e.g., SAO, DBF, ALF) are used in the computation of the offset term. In some embodiments, when the offset term is calculated, MC results plus residual (generated by inverse transform) are used in the computation of the offset without loop filtering. The calculation of the offset term without loop filtering in a video encoder will be described by reference to FIGS. 12 and 14 below. The calculation of the offset term in a video decoder without loop filtering will be described by reference to FIGS. 15 and 16 below.

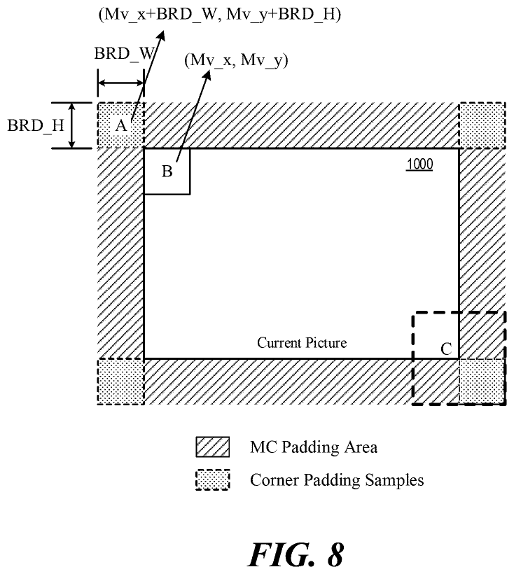

When generating padding samples outside the boundary of a reference picture, the generation of the padding samples at the four corners may depend on (and therefore has to wait for) intermediate MC padding results. In some embodiments, for the four corners of the first order reference picture, motion-compensation-based inter-prediction approach can be used to derive boundary samples, instead of waiting for intermediate MC padding results. FIG. 8 illustrates motion compensation for generating OOB padding samples at corner boundary of a picture (for example, the current picture). The figure illustrates a current picture 1000. An OOB region A lies at the corner of the current picture 1000. When deriving padding samples in region A, motion information of a block at a nearest corner region (region B) in the picture 1000 is utilized to perform motion compensation for region A. The MV of region B (Mv_x, Mv_y) may be added some offset to perform motion compensation for region A, for example, (Mv_x+BRD_W, Mv_y+BRD_H), BRD_W and BRD_H being the width and height of the corner padding region A. In some embodiments, when using motion to generate padding samples at picture corners, a larger MC block covering both sides of the picture boundary may be generated by motion compensation to provide OOB padding samples, such as region C in FIG. 8.

In some embodiments, when the motion information of the current block/position is bi-prediction, two MVs are used, and the MV pointing to the reference picture or block with the smaller QP is selected to be used in motion compensation of the current block. In some embodiment, when the motion information of current block is bi-prediction, two MVs are firstly checked for whether the reference blocks are inside reference picture boundary or not. If both reference blocks are inside the boundaries of reference pictures, the MV pointing to the reference picture with smaller QP is selected in motion compensation. If one of the reference blocks is outside the reference picture boundary, the MV pointing to the reference block that lies (at least partially) within reference picture boundary is selected, regardless of QP value.

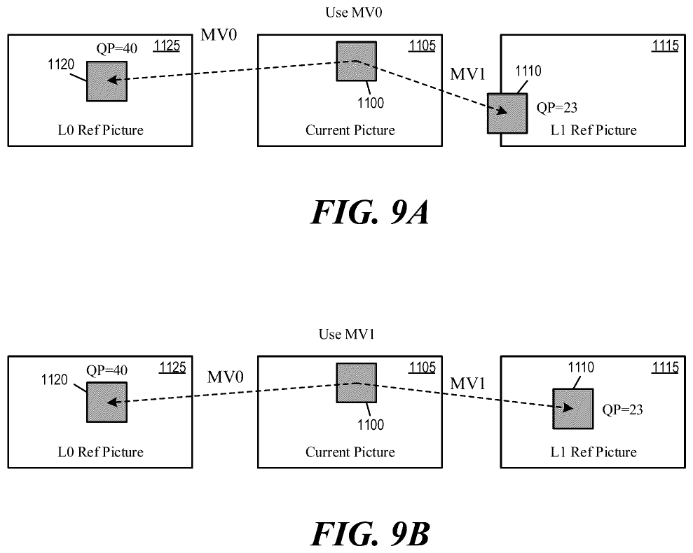

FIGS. 9A-B conceptually illustrate selecting one of two motion vectors for a bi-prediction block based on OOB checks and QP values. The figures illustrate a current block 1100 that is bi-predicted, having two MVs (MV1 and MV0) pointing to a reference block 1110 in a L1 reference picture 1115 and a reference block 1120 in a L0 reference picture 1125. The reference block 1110 has QP=23 and the reference block 1120 has QP=40.

FIG. 9A illustrates a scenario in which one of the two MVs refers to a reference block that is OOB. In the example, the reference block 1110 is OOB with respect to the L1 reference picture 1115, while the reference block 1120 is not OOB. MV0/the L0 reference block 1120 is therefore selected for motion compensation of the current block 1100, regardless of the QP value of the two reference blocks.

FIG. 9B illustrates a scenario in which both MVs refer to reference blocks that are within picture boundaries. In this case, the reference block with the smaller QP is selected for motion compensation of the current block 1100, namely the L1 reference block having QP of 23.

In some embodiments, when the motion information of the current block/position is bi-prediction, two MVs are used and the MV pointing to the reference picture with the smaller temporal distance (from the current picture) is selected to be used in motion compensation of the current block. In some embodiments, when the motion information of the current block/position is bi-prediction, two MVs are firstly checked to determine whether the reference blocks are inside the reference picture boundaries or not. If both reference blocks are inside their respective reference picture boundaries, the MV pointing to the reference picture with the smaller temporal distance (from the current picture) is selected in motion compensation. If one of the reference blocks is outside of the reference picture boundary, the MV pointing to the reference block that lies inside reference picture boundary is selected, regardless of temporal distance.

In some embodiments, when performing motion compensation for boundary samples, out-of-boundary (OOB) check is performed. If one of the reference blocks is OOB, MC results may directly come from the non-OOB reference block, or combination of partial OOB reference block and non-OOB reference block. If both of the reference blocks are OOB, MC results may be the combination of partial non-OOB region in OOB reference blocks, or the fused final predictors from two OOB reference blocks.

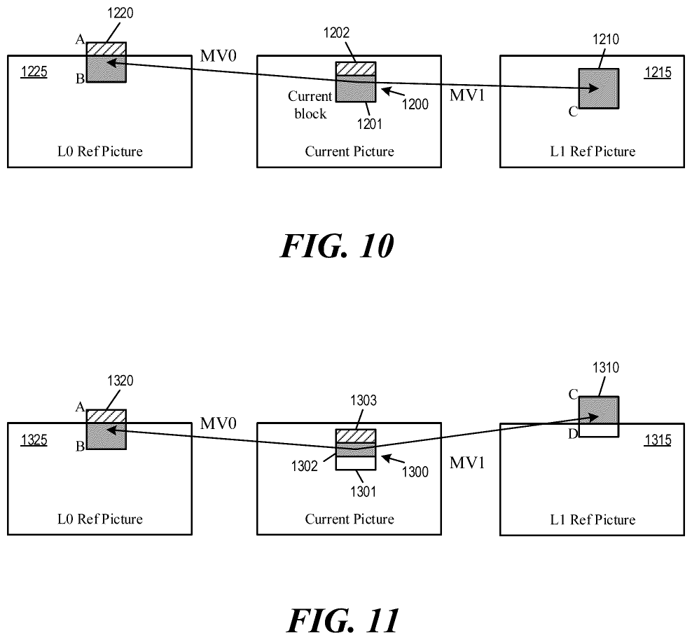

FIG. 10 illustrates coding a bi-prediction current block 1200 when one of the two reference blocks is OOB. In the figure, the motion information of the current block/position indicates bi-prediction, and there are two reference blocks in two reference pictures. In the figure, one reference block 1210 is inside the boundary of the reference picture 1215 and a reference block 1220 is partially outside the boundary of the reference picture 1225. When deriving boundary samples, two separate parts 1201 and 1202 in the current block 1200 are determined based on different parts in the reference blocks (e.g., based on the height of B in Reference block 1220). For example, lower part 1201 of boundary samples is generated using bi-prediction MC results from reference block 1220 part B and reference block 1210 part C, while the upper part 1202 of boundary samples are generated using uni-prediction MC results from reference block 1210 part C or bi-prediction from reference block 1220 part A and reference block 1210 part C or repetitive padding from existing lower part of boundary samples.

FIG. 11 illustrates a bi-prediction current block 1300 when both reference blocks are OOB. As illustrated, two reference blocks 1310 (in reference picture 1315) and 1320 (in reference picture 1325) are both outside their respective reference picture boundaries. When deriving boundary samples, three separate parts 1301, 1302, and 1303 in the current block 1300 are determined based on different parts in reference blocks 1310 and 1320 (e.g., reference block 1310 part D height to determine lower part 1301, reference block 1320 part B height minus reference block 1310 part D height to determine middle part 1302). For example, the lower part 1301 of boundary samples is generated using bi-prediction MC results from reference block 1320 part B and reference block 1310 part D. The middle part of boundary samples can be generated using uni-prediction MC results from reference block 1310 part B or bi-prediction MC results from reference block 1320 part B and Reference block 1310 part D. The upper part of boundary samples can be generated using uni-prediction MC results from reference block 1320 part A or reference block 1310 part C or bi-prediction MC results from reference block 1320 part A and reference block 1310 part C or repetitive padding from existing middle part of boundary samples.

As mentioned above, a boundary block that is used to provide the motion information for generating the padding samples of a current picture may be bi-directionally predicted, i.e., the motion information may include two motion vectors pointing to reference samples/blocks in two reference pictures. A method for selecting one of the two MVs based on comparing distances from the picture boundary is described by reference to FIG. 5 above. In some embodiments, the methods for selecting one of the two MVs of a bi-prediction current block in the current picture described above by reference to FIGS. 9A-B can be applied to select one of the two MVs of a bi-directionally predicted boundary block of a current picture. In some embodiments, the method for blending the prediction samples derived from the two MVs described above by reference to FIGS. 10, and 11, can be used to blend the pixels from the two reference blocks referred by the two MVs of the bi-directionally predicted boundary block of a current picture, which will be used as one of the one or more reference pictures.

For example, the method described in FIGS. 9A-B can be used to select one of two MVs of the boundary block 705 of the current reference picture 700 in FIG. 5. Namely, the video coder may select between MV0 and MV1 based on whether one of the reference blocks 720 and 721 is OOB, and if not, based on which of the two reference blocks has a smaller QP, or based on which of the two reference pictures 710 and 711 has a smaller temporal distance (from the first order reference picture or the current picture). The selected MV of the boundary block 701 is in turn used to generate the padding samples of the current picture 700, which will be taken as one of the one or more reference pictures.

In some embodiments, when the current block is in subblock mode (e.g., affine mode or SbTMVP mode), corresponding subblock mode model is used to generate the motion information. When the reference block on reference picture is OOB, the corresponding affine mode model or SbTMVP subblock motion is used to generate the motion information.

In some embodiments, when OOB condition is checked for a reference block in a reference picture, the OOB condition will also consider extra padded regions in the reference picture. In some embodiments, when OOB condition is checked for a reference block in a reference picture, MC padding region is also considered for OOB condition.

Any of the foregoing proposed methods can be implemented in encoders and/or decoders. For example, any of the proposed methods can be implemented in predictor derivation module of an encoder, and/or a predictor derivation module of a decoder. Alternatively, any of the proposed methods can be implemented as a circuit coupled to the predictor derivation module of the encoder and/or the predictor derivation module of the decoder, so as to provide the information needed by the predictor derivation module.

### II. Example Video Encoder

FIG. 12 illustrates an example video encoder 1400 that may use motion compensation to generate OOB padding samples. As illustrated, the video encoder 1400 receives input video signal from a video source 1405 and encodes the signal into bitstream 1495. The video encoder 1400 has several components or modules for encoding the signal from the video source 1405, at least including some components selected from a transform module 1410, a quantization module 1411, an inverse quantization module 1414, an inverse transform module 1415, an intra-picture estimation module 1420, an intra-prediction module 1425, a motion compensation module 1430, a motion estimation module 1435, an in-loop filter 1445, a reconstructed picture buffer 1450, a MV buffer 1465, and a MV prediction module 1475, and an entropy encoder 1490. The motion compensation module 1430 and the motion estimation module 1435 are part of an inter-prediction module 1440.

In some embodiments, the modules 1410-1490 are modules of software instructions being executed by one or more processing units (e.g., a processor) of a computing device or electronic apparatus. In some embodiments, the modules 1410-1490 are modules of hardware circuits implemented by one or more integrated circuits (ICs) of an electronic apparatus. Though the modules 1410-1490 are illustrated as being separate modules, some of the modules can be combined into a single module.

The video source 1405 provides a raw video signal that presents pixel data of each video frame without compression. A subtractor 1408 computes the difference between the raw video pixel data of the video source 1405 and the predicted pixel data 1413 from the motion compensation module 1430 or intra-prediction module 1425 as prediction residual 1409. The transform module 1410 converts the difference (or the residual pixel data or residual signal 1408) into transform coefficients (e.g., by performing Discrete Cosine Transform, or DCT). The quantization module 1411 quantizes the transform coefficients into quantized data (or quantized coefficients) 1412, which is encoded into the bitstream 1495 by the entropy encoder 1490.

The inverse quantization module 1414 de-quantizes the quantized data (or quantized coefficients) 1412 to obtain transform coefficients, and the inverse transform module 1415 performs inverse transform on the transform coefficients to produce reconstructed residual 1419. The reconstructed residual 1419 is added with the predicted pixel data 1413 to produce reconstructed pixel data 1417. In some embodiments, the reconstructed pixel data 1417 is temporarily stored in a line buffer (not illustrated) for intra-picture prediction and spatial MV prediction. The reconstructed pixels are filtered by the in-loop filter 1445 and stored in the reconstructed picture buffer 1450. In some embodiments, the reconstructed picture buffer 1450 is a storage external to the video encoder 1400. In some embodiments, the reconstructed picture buffer 1450 is a storage internal to the video encoder 1400.

The intra-picture estimation module 1420 performs intra-prediction based on the reconstructed pixel data 1417 to produce intra prediction data. The intra-prediction data is provided to the entropy encoder 1490 to be encoded into bitstream 1495. The intra-prediction data is also used by the intra-prediction module 1425 to produce the predicted pixel data 1413.

The motion estimation module 1435 performs inter-prediction by producing MVs to reference pixel data of previously decoded frames stored in the reconstructed picture buffer 1450. These MVs are provided to the motion compensation module 1430 to produce predicted pixel data.

Instead of encoding the complete actual MVs in the bitstream, the video encoder 1400 uses MV prediction to generate predicted MVs, and the difference between the MVs used for motion compensation and the predicted MVs is encoded as residual motion data and stored in the bitstream 1495.

The MV prediction module 1475 generates the predicted MVs based on reference MVs that were generated for encoding previously video frames, i.e., the motion compensation MVs that were used to perform motion compensation. The MV prediction module 1475 retrieves reference MVs from previous video frames from the MV buffer 1465. The video encoder 1400 stores the MVs generated for the current video frame in the MV buffer 1465 as reference MVs for generating predicted MVs.

The MV prediction module 1475 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 1495 by the entropy encoder 1490.

The entropy encoder 1490 encodes various parameters and data into the bitstream 1495 by using entropy-coding techniques such as context-adaptive binary arithmetic coding (CABAC) or Huffman encoding. The entropy encoder 1490 encodes various header elements, flags, along with the quantized transform coefficients 1412, and the residual motion data as syntax elements into the bitstream 1495. The bitstream 1495 is in turn stored in a storage device or transmitted to a decoder over a communications medium such as a network.

The in-loop filter 1445 performs filtering or smoothing operations on the reconstructed pixel data 1417 to reduce the artifacts of coding, particularly at boundaries of pixel blocks. In some embodiments, the filtering or smoothing operations performed by the in-loop filter 1445 include deblock filter (DBF), sample adaptive offset (SAO), and/or adaptive loop filter (ALF).

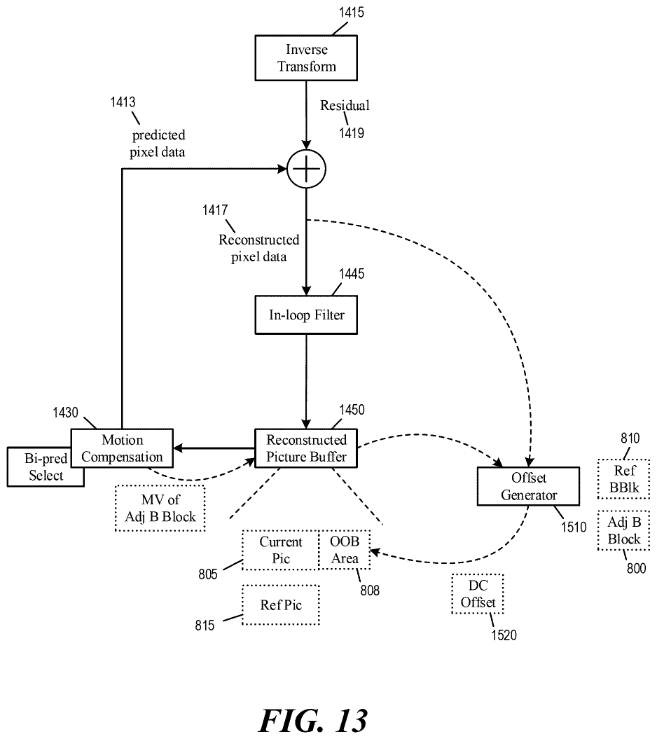

FIG. 13 illustrates portions of the video encoder 1400 that derive OOB padding samples. Specifically, the figure illustrates the portions of the video encoder data path that generates an offset value to be added to the OOB padding samples.

The video encoder 1400 may pre-populate the OOB region (e.g., 808 of FIG. 6) of the current picture (e.g., 805 of FIG. 6) with padding samples. To generate the padding samples of the OOB region of the current picture, the motion compensation module 1430 uses a MV of an adjacent boundary block (e.g., 800 of FIG. 6) to fetch reference samples of a reference block (e.g., 810 of FIG. 6) in a reference picture (e.g., 815 of FIG. 6). The reference samples are provided as predicted pixel data 1413 and combined with the inverse transformed residual 1419 to become the reconstructed pixel data 1417 of the OOB region of the first order reference picture. The adjacent boundary block may be a corner block of the first order reference picture used to provide OOB padding samples at a corner region of the OOB region of the first order reference block.

To generate the offset value for the OOB padding samples, the samples of a boundary block (e.g., 800 of FIG. 6) of the current picture and the samples of a corresponding reference block (e.g., 810 of FIG. 6) are fetched from the reconstructed picture buffer 1450 and provided to an offset generator 1510 without any operation by the in-loop filter 1445. In some embodiments, the reconstructed pixel data 1417 (sum of predicted pixel data 1413 and residual 1419) is used to provide the samples of the boundary block (e.g., 800) and the samples of the corresponding reference block (e.g., 810). The offset generator 1510 computes the DC values of both blocks and use the difference between the two DC values to derive a DC offset value 1520. The derived DC offset value 1520 is then added to the OOB padding samples in the OOB region 808 stored in the reconstructed picture buffer 1450.

When performing motion compensation to derive the OOB padding samples based on the motion information of the adjacent boundary block (e.g., 800), the motion compensation module 1430 may determine whether the adjacent boundary block is a bi-prediction block having two MVs locating two (second order) reference blocks in two second order reference pictures. If so, the motion compensation module 1430 may select one of the two motion vectors based on whether the two corresponding reference blocks are out-of-bound, or which of the two reference blocks have the smaller QP, or which of the two second order reference pictures have the smaller temporal distance (from the current picture or from the first order reference picture). The selected MV (and therefore the corresponding second order reference block) is then used to generate the padding samples of in the OOB region (e.g., 308).

FIG. 14 conceptually illustrates a process 1600 for generating and using padding samples in OOB regions of a reference picture. In some embodiments, one or more processing units (e.g., a processor) of a computing device implementing the encoder 1400 performs the process 1600 by executing instructions stored in a computer readable medium. In some embodiments, an electronic apparatus implementing the encoder 1400 performs the process 1600.

The encoder receives (at block 1610) data to be encoded as a current picture of a video. The encoder generates (at block 1620) out-of-bound (OOB) padding samples of the current picture by using a motion information of a boundary block of the current picture to fetch samples of a first reference block in a first reference picture.

In some embodiments, OOB padding samples in a corner region outside the current picture are generated based on a boundary block at the corner of the current picture. The first reference block may provide samples that span both sides of the boundary of the current picture. When using the motion information of the boundary block to generate the OOB samples, the encoder may update the motion information based on a position of the OOB samples relative to the boundary of the current picture.

In some embodiments, the boundary block may be coded by bi-prediction based on first and second motion vectors, the first motion vector referencing the first reference block and the second motion vector referencing a second reference block in a second reference picture. The encoder may select one of the first and second reference blocks based on whether the first or second reference blocks are OOB. In some embodiments, when the first and second reference blocks are not OOB, the encoder may select one of the first and second reference blocks based on which of the first and second reference blocks has a smaller quantization parameter (QP), or based on which of the first and second reference pictures has a smaller temporal distance.

The encoder computes (at block 1630) an offset value based on a first DC value of the boundary block and a second DC value of the first reference block. The first and second DC values are calculated based on reconstructed samples without in-loop filtering. The encoder applies (at block 1640) the offset value to the padding samples.

The encoder derives (at block 1650) a candidate reference picture based on the current picture and the padding samples for encoding a subsequent picture in the video. For example, a block in the subsequent picture of the video maybe encoded by motion compensation using the OOB padding samples because the block references OOB samples of the current picture.

### III. Example Video Decoder

In some embodiments, an encoder may signal (or generate) one or more syntax element in a bitstream, such that a decoder may parse said one or more syntax element from the bitstream.

FIG. 15 illustrates an example video decoder 1700 that may use motion compensation to generate OOB padding samples. As illustrated, the video decoder 1700 is an image-decoding or video-decoding circuit that receives a bitstream 1795 and decodes the content of the bitstream into pixel data of video frames for display. The video decoder 1700 has several components or modules for decoding the bitstream 1795, including some components selected from an inverse quantization module 1711, an inverse transform module 1710, an intra-prediction module 1725, a motion compensation module 1730, an in-loop filter 1745, a decoded picture buffer 1750, a MV buffer 1765, a MV prediction module 1775, and a parser 1790. The motion compensation module 1730 is part of an inter-prediction module 1740.

In some embodiments, the modules 1710-1790 are modules of software instructions being executed by one or more processing units (e.g., a processor) of a computing device. In some embodiments, the modules 1710-1790 are modules of hardware circuits implemented by one or more ICs of an electronic apparatus. Though the modules 1710-1790 are illustrated as being separate modules, some of the modules can be combined into a single module.

The parser 1790 (or entropy decoder) receives the bitstream 1795 and performs initial parsing according to the syntax defined by a video-coding or image-coding standard. The parsed syntax element includes various header elements, flags, as well as quantized data (or quantized coefficients) 1712. The parser 1790 parses out the various syntax elements by using entropy-coding techniques such as context-adaptive binary arithmetic coding (CABAC) or Huffman encoding.

The inverse quantization module 1711 de-quantizes the quantized data (or quantized coefficients) 1712 to obtain transform coefficients, and the inverse transform module 1710 performs inverse transform on the transform coefficients 1716 to produce reconstructed residual signal 1719. The reconstructed residual signal 1719 is added with predicted pixel data 1713 from the intra-prediction module 1725 or the motion compensation module 1730 to produce decoded pixel data 1717. The decoded pixels data are filtered by the in-loop filter 1745 and stored in the decoded picture buffer 1750. In some embodiments, the decoded picture buffer 1750 is a storage external to the video decoder 1700. In some embodiments, the decoded picture buffer 1750 is a storage internal to the video decoder 1700.

The intra-prediction module 1725 receives intra-prediction data from bitstream 1795 and according to which, produces the predicted pixel data 1713 from the decoded pixel data 1717 stored in the decoded picture buffer 1750. In some embodiments, the decoded pixel data 1717 is also stored in a line buffer (not illustrated) for intra-picture prediction and spatial MV prediction.

In some embodiments, the content of the decoded picture buffer 1750 is used for display. A display device 1755 either retrieves the content of the decoded picture buffer 1750 for display directly, or retrieves the content of the decoded picture buffer to a display buffer. In some embodiments, the display device receives pixel values from the decoded picture buffer 1750 through a pixel transport.

The motion compensation module 1730 produces predicted pixel data 1713 from the decoded pixel data 1717 stored in the decoded picture buffer 1750 according to motion compensation MVs (MC MVs). These motion compensation MVs are decoded by adding the residual motion data received from the bitstream 1795 with predicted MVs received from the MV prediction module 1775.

The MV prediction module 1775 generates the predicted MVs based on reference MVs that were generated for decoding previous video frames, e.g., the motion compensation MVs that were used to perform motion compensation. The MV prediction module 1775 retrieves the reference MVs of previous video frames from the MV buffer 1765. The video decoder 1700 stores the motion compensation MVs generated for decoding the current video frame in the MV buffer 1765 as reference MVs for producing predicted MVs.

The in-loop filter 1745 performs filtering or smoothing operations on the decoded pixel data 1717 to reduce the artifacts of coding, particularly at boundaries of pixel blocks. In some embodiments, the filtering or smoothing operations performed by the in-loop filter 1745 include deblock filter (DBF), sample adaptive offset (SAO), and/or adaptive loop filter (ALF).

FIG. 16 illustrates portions of the video decoder 1700 that derive OOB padding samples. Specifically, the figure illustrates the portions of the video decoder data path that generates an offset value to be added to the OOB padding samples.

The video decoder 1700 may pre-populate the OOB region (e.g., 808 of FIG. 6) of the current picture (e.g., 805 of FIG. 6) with padding samples. To generate the padding samples of the OOB region of the current picture, the motion compensation module 1730 uses a MV of an adjacent boundary block (e.g., 800 of FIG. 6) to fetch reference samples of a reference block (e.g., 810 of FIG. 6) in a reference picture (e.g., 815 of FIG. 6). The reference samples are provided as predicted pixel data 1713 and combined with the inverse transformed residual 1719 to become the reconstructed pixel data 1717 of the OOB region of the first order reference picture. The adjacent boundary block may be a corner block of the first order reference picture used to provide OOB padding samples at a corner region of the OOB region of the first order reference block.

To generate the offset value for the OOB padding samples, the samples of a boundary block (e.g., 800 of FIG. 6) of the current picture and the samples of a corresponding reference block (e.g., 810 of FIG. 6) are fetched from the decoded picture buffer 1750 and provided to an offset generator 1810 without any operation by the in-loop filter 1745. In some embodiments, the reconstructed pixel data 1717 (sum of predicted pixel data 1713 and residual 1719) is used to provide the samples of the boundary block (e.g., 800) and the samples of the corresponding reference block (e.g., 810). The offset generator 1810 computes the DC values of both blocks and use the difference between the two DC values to derive a DC offset value 1520. The derived DC offset value 1520 is then added to the OOB padding samples in the OOB region 808 stored in the decoded picture buffer 1750.

When performing motion compensation to derive the OOB padding samples based on the motion information of the adjacent boundary block (e.g., 800), the motion compensation module 1730 may determine whether the adjacent boundary block is a bi-prediction block having two MVs locating two (second order) reference blocks in two second order reference pictures. If so, the motion compensation module 1730 may select one of the two motion vectors based on whether the two corresponding reference blocks are out-of-bound, or which of the two reference blocks have the smaller QP, or which of the two second order reference pictures have the smaller temporal distance (from the current picture or from the first order reference picture). The selected MV (and therefore the corresponding second order reference block) is then used to generate the padding samples of in the OOB region (e.g., 308).

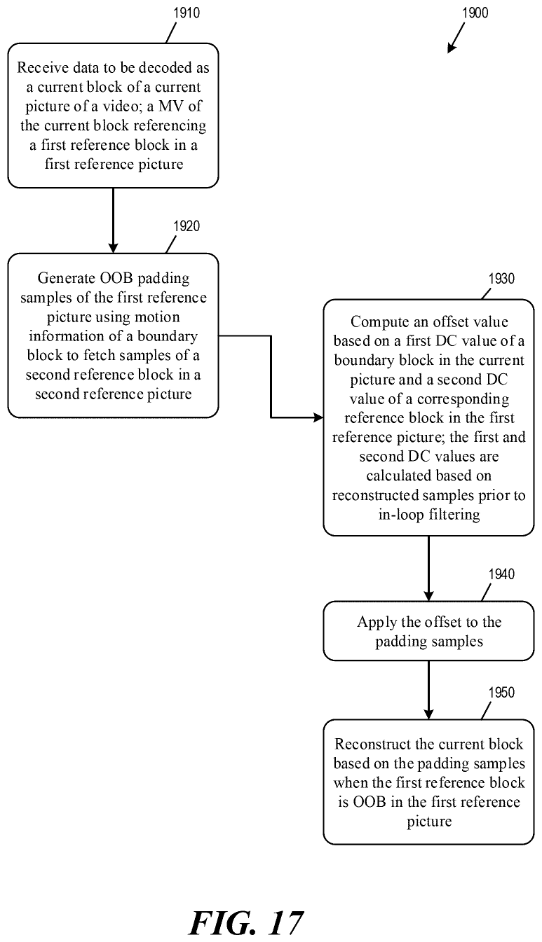

FIG. 17 conceptually illustrates a process 1900 for generating and using padding samples in OOB regions of a reference picture. In some embodiments, one or more processing units (e.g., a processor) of a computing device implementing the decoder 1700 performs the process 1900 by executing instructions stored in a computer readable medium. In some embodiments, an electronic apparatus implementing the decoder 1700 performs the process 1900.

The decoder receives (at block 1910) data to be decoded as a current picture of a video. The decoder generates (at block 1920) out-of-bound (OOB) padding samples of the current picture by using a motion information of a boundary block of the current picture to fetch samples of a first reference block in a first reference picture.

In some embodiments, OOB padding samples in a corner region outside the current picture are generated based on a boundary block at the corner of the current picture. The first reference block may provide samples that span both sides of the boundary of the current picture. When using the motion information of the boundary block to generate the OOB samples, the decoder may update the motion information based on a position of the OOB samples relative to the boundary of the current picture.

In some embodiments, the boundary block may be coded by bi-prediction based on first and second motion vectors, the first motion vector referencing the first reference block and the second motion vector referencing a second reference block in a second reference picture. The decoder may select one of the first and second reference blocks based on whether the first or second reference blocks are OOB. In some embodiments, when the first and second reference blocks are not OOB, the decoder may select one of the first and second reference blocks based on which of the first and second reference blocks has a smaller quantization parameter (QP), or based on which of the first and second reference pictures has a smaller temporal distance.

The decoder computes (at block 1930) an offset value based on a first DC value of the boundary block and a second DC value of the first reference block. The first and second DC values are calculated based on reconstructed samples without in-loop filtering. The decoder applies (at block 1940) the offset value to the padding samples.

The decoder derives (at block 1950) a candidate reference picture based on the current picture and the padding samples for decoding a subsequent picture in the video. For example, a block in the subsequent picture of the video maybe reconstructed by motion compensation using the OOB padding samples because the block references OOB samples of the current picture.

### IV. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions.

Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

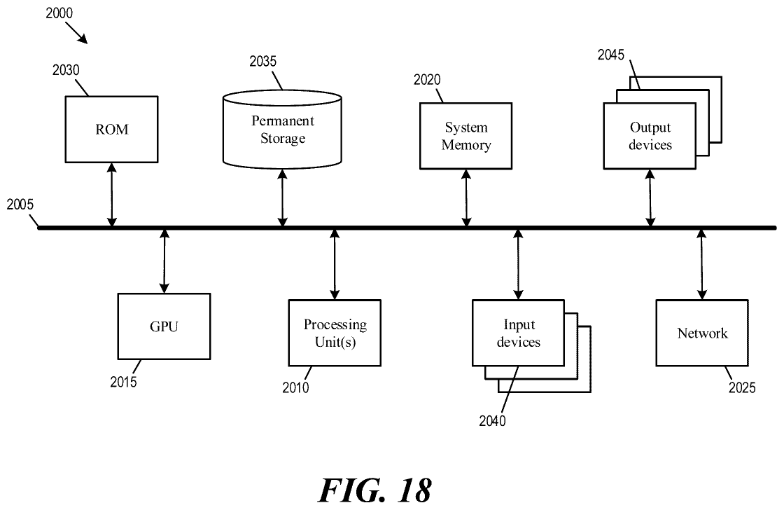

FIG. 18 conceptually illustrates an electronic system 2000 with which some embodiments of the present disclosure are implemented. The electronic system 2000 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 2000 includes a bus 2005, processing unit(s) 2010, a graphics-processing unit (GPU) 2015, a system memory 2020, a network 2025, a read-only memory 2030, a permanent storage device 2035, input devices 2040, and output devices 2045.

The bus 2005 collectively represents all system, peripheral, and chipset buses that communicatively connect the numerous internal devices of the electronic system 2000. For instance, the bus 2005 communicatively connects the processing unit(s) 2010 with the GPU 2015, the read-only memory 2030, the system memory 2020, and the permanent storage device 2035.

From these various memory units, the processing unit(s) 2010 retrieves instructions to execute and data to process in order to execute the processes of the present disclosure. The processing unit(s) may be a single processor or a multi-core processor in different embodiments. Some instructions are passed to and executed by the GPU 2015. The GPU 2015 can offload various computations or complement the image processing provided by the processing unit(s) 2010.

The read-only-memory (ROM) 2030 stores static data and instructions that are used by the processing unit(s) 2010 and other modules of the electronic system. The permanent storage device 2035, on the other hand, is a read-and-write memory device. This device is a non-volatile memory unit that stores instructions and data even when the electronic system 2000 is off. Some embodiments of the present disclosure use a mass-storage device (such as a magnetic or optical disk and its corresponding disk drive) as the permanent storage device 2035.

Other embodiments use a removable storage device (such as a floppy disk, flash memory device, etc., and its corresponding disk drive) as the permanent storage device. Like the permanent storage device 2035, the system memory 2020 is a read-and-write memory device. However, unlike storage device 2035, the system memory 2020 is a volatile read-and-write memory, such a random access memory. The system memory 2020 stores some of the instructions and data that the processor uses at runtime. In some embodiments, processes in accordance with the present disclosure are stored in the system memory 2020, the permanent storage device 2035, and/or the read-only memory 2030. For example, the various memory units include instructions for processing multimedia clips in accordance with some embodiments. From these various memory units, the processing unit(s) 2010 retrieves instructions to execute and data to process in order to execute the processes of some embodiments.

The bus 2005 also connects to the input and output devices 2040 and 2045. The input devices 2040 enable the user to communicate information and select commands to the electronic system. The input devices 2040 include alphanumeric keyboards and pointing devices (also called “cursor control devices”), cameras (e.g., webcams), microphones or similar devices for receiving voice commands, etc. The output devices 2045 display images generated by the electronic system or otherwise output data. The output devices 2045 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 18, bus 2005 also couples electronic system 2000 to a network 2025 through a network adapter (not shown). In this manner, the computer can be a part of a network of computers (such as a local area network (“LAN”), a wide area network (“WAN”), or an Intranet, or a network of networks, such as the Internet. Any or all components of electronic system 2000 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 14 and FIG. 17) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data to be encoded or decoded as a current picture of a video;
generating out-of-bound (OOB) padding samples of the current picture by using a motion information of a boundary block of the current picture to fetch samples of a first reference block in a first reference picture;
computing an offset value based on a first DC value of the boundary block and a second DC value of the first reference block, wherein the first and second DC values are calculated based on reconstructed samples without in-loop filtering;
applying the offset value to the padding samples; and
deriving a candidate reference picture based on the current picture and the padding samples for encoding or decoding a subsequent picture in the video.

2. The video coding method of claim 1, wherein OOB padding samples in a corner region outside the current picture are generated based on a boundary block at the corner of the current picture.

3. The video coding method of claim 2, wherein the first reference block provides samples that span both sides of the boundary of the current picture.

4. The video coding method of claim 1, wherein using the motion information of the boundary block to generate the OOB padding samples comprises updating the motion information based on a position of the OOB padding samples relative to the boundary of the current picture.

5. The video coding method of claim 1, wherein a block in the subsequent picture of the video is coded by motion compensation using the OOB padding samples.

6. The video coding method of claim 1, wherein the boundary block is coded by bi-prediction based on first and second motion vectors, the first motion vector referencing the first reference block and the second motion vector referencing a second reference block in a second reference picture.

7. The video coding method of claim 6, further comprising selecting one of the first and second reference blocks based on whether the first or second reference blocks are OOB.

8. The video coding method of claim 7, further comprising:
when the first and second reference blocks are not OOB, selecting one of the first and second reference blocks based on which of the first and second reference blocks has a smaller quantization parameter (QP).

9. The video coding method of claim 7, further comprising:
when the first and second reference blocks are not OOB, selecting one of the first and second reference blocks based on which of the first and second reference pictures has a smaller temporal distance.

10. An electronic apparatus comprising:
a video coder circuit configured to perform operations comprising:
receiving data to be encoded or decoded as a current picture of a video;
generating out-of-bound (OOB) padding samples of the current picture by using a motion information of a boundary block of the current picture to fetch samples of a first reference block in a first reference picture;
computing an offset value based on a first DC value of the boundary block and a second DC value of the first reference block, wherein the first and second DC values are calculated based on reconstructed samples without in-loop filtering;
applying the offset value to the padding samples; and
deriving a candidate reference picture based on the current picture and the padding samples for encoding or decoding a subsequent picture in the video.
